(19) United States
(12) Patent Application Publication
(10) Pub. No.: US 2013/0042589 A1
(43) Pub. Date: Feb. 21, 2013

(54) FILTER INCLUDING A HOT MELT COATED CONTINUOUS SUBSTRATE

(71) Applicants: Michael J. Chanak, Forest Lake, MN (US); Dennis A. Bradshaw, Damascus, OR (US); John T. Channon, Dellwood, MN (US)

(72) Inventors: Michael J. Chanak, Forest Lake, MN (US); Dennis A. Bradshaw, Damascus, OR (US); John T. Channon, Dellwood, MN (US)

(21) Appl. No.: 13/213,435

(22) Filed: Aug. 19, 2011

Related U.S. Application Data
(60) Provisional application No. 61/375,633.

(51) Int. Cl. B01D 46/52; B32B 7/12; B32B 37/04; B01D 39/14; B65C 9/25; B32B 38/18

(52) U.S. Cl. 55/521; 156/320; 156/204; 156/272.2; 55/524; 428/343

(57) ABSTRACT

The invention is directed to a filter including filter media and a continuous substrate coated on at least one surface with a hot melt adhesive. The hot melt adhesive includes a polymer and alternately, at least one additional component selected from the group consisting of tackifying agent, wax and filler.

This application claims priority to U.S. Ser. No. 61/375,633 filed Aug. 20, 2010, which is incorporated herein.

### BACKGROUND

The invention is directed to a filter including a continuous substrate coated on at least one surface with a hot melt adhesive.

Hot melts find use as adhesives, coatings and sealants. In one application hot melt adhesives are useful as adhesives in the manufacture of filters, for example in filter pleating or pleat stabilization. In filter pleating, the hot melt adhesive is extruded in a series of beads onto filter media, the media is folded into pleats, with each filter pleat being adhered to the next by an adhesive to adhesive bond. The adhesive holds the pleats a fixed distance apart from each other to allow air flow through a greater surface area of filter media. In pleat stabilization, at least one bead is extruded over the top of an already pleated filter to stabilize the pleats. In pleat stabilization, the hot melt adhesive is adhered directly to the filter media.

Hot melt adhesive is applied at elevated temperatures. As such, on a manufacturing line hot melt adhesives are generally held in application pots, at temperatures of from around 93.3° C. (200° F.) to around 204.4° C. (400° F.), for extended periods of time.

Hot melt adhesives used in filter manufacturing also have additional requirements depending on the end use of the filter. For some filters (e.g. engine air filters), it is required that the adhesive have high heat and oil resistance. Highly heat resistant adhesives often require higher (e.g. greater that around 176.7° C. (350° F.)) application temperatures. For other filters, it is required that the hot melt adhesive be flame retardant. Flame retardant hot melt adhesives can contain components (e.g. chlorinated paraffin and hydrated filler) that are not heat stable; this can result in the adhesive having poor heat stability

### SUMMARY

In one aspect the invention features a filter including filter media and a continuous substrate coated on at least one surface with a hot melt adhesive, the hot melt adhesive including polymer and at least one component selected from the group consisting of tackifying agent, wax and filler. Exemplary filters include air filters including e.g. engine air filters. In another aspect, the invention features a continuous substrate coated on at least one surface with a hot melt adhesive comprising a flame retardant and/or smoke suppressant compound, as well as filters comprising filter media and this particular continuous substrate. In still another aspect, the hot melt adhesives used in the present invention include filler, in some cases the filler is a hydrated inorganic compound. In other embodiments, the hot melt adhesive used in the present invention consists essentially of a polyamide, where the polyamide optionally includes at least one dimer acid, at least one dicarboxylic acid and ethylene diamine.

Another aspect of the invention features a method of bonding filter media to a continuous substrate coated on at least one surface with a hot melt adhesive, said method including the steps of obtaining a continuous substrate coated on at least one surface with a hot melt adhesive, heating the coated continuous substrate under tension, and forming a bond of the heated, coated continuous substrate to filter media. In one embodiment, the continuous coated substrate is pre coated. The inventors discovered that this method may simplify filter manufacturing lines since filter manufacturers may purchase the pre coated continuous substrate instead of adhesive, and they no longer need a heated pot of adhesive and related equipment (premelter, hose, nozzles, etc.) to make filters. Rather the coated continuous substrate may be heated as applied, for example by IR light.

Other features and advantages will be apparent from the following description of the preferred embodiments and from the claims.

### GLOSSARY

Continuous substrate refers to any cross-sectional shape of continuous material.

String refers to a continuous substrate having a substantially circular cross-section.

Tape refers to a continuous substrate having a substantially flat or substantially rectangular cross-section.

Ethylene copolymer refers to copolymers and terpolymers of ethylene

### DETAILED DESCRIPTION

The filter includes filter media (e.g. the media that filters) and a continuous substrate with a coating on at least one surface including a hot melt adhesive. The hot melt adhesive includes a polymer. Alternately, the hot melt consists essentially of a polymer. Alternately, the hot melt adhesive includes a polymer and at least one of tackifying agent, filler, or wax.

### Continuous Substrate

The continuous substrate can be one continuos filament or it can be made from multiple filaments (smaller filaments of various sizes wound together to form a continuous substrate). The filaments can include fiber material, spun yarn, zero-twist yarn, core spun yarn and combinations thereof. The filaments may further include any of a variety of natural or synthetic materials including for example fiberglass, polyester, polyamide (e.g. nylon), polyvinyl alcohol, rayon, nylon, aramide (KEVLAR) and mixtures thereof. The continuous substrate may be saturated with various materials prior to coating with the hot melt adhesive to add characteristics to it such as for example flame retardant and smoke suppressing properties.

The continuous substrate may vary in cross sectional shape and size (e.g. string or tape). When the continuous substrate is a string having a substantially circular cross-section, it may range in diameter from about 0.01 mm to about 5 mm, from about 0.10 mm to about 4 mm, from about 0.25 mm to about 3 mm, or even from about 1 mm to about 2 mm. The diameter of the string containing adhesive will typically be larger than the string alone, but it is also possible for the diameter of the coated string to fall within the above mentioned ranges, or even larger. The thickness of the coated string (or the thickness of the continuous substrate) are selected, in part, based upon the desired gap in filter pleats when used for filter pleating. For example, if the desired gap is 1 mm, and the coated string will be laid on the filter media such that when pleats are formed, the coated string on one surface of the pleat bonds to the coated string on the opposing surface of the pleats, the desired coated string diameter would be approximately 0.5 mm (or a bit larger to account for some compression).

Similarly, when the continuous substrate is not substantially circular in cross-section, but is more rectangular as when a tape or ribbon is used, or several strands of string are used, the height of the continuous substrate may be from about 0.01 mm to about 5 mm, from about 0.10 mm to about 4 mm, from about 0.25 mm to about 3 mm, or even from about 1 mm to about 2 mm. The width of the continuous substrate may be, for example, at least about 0.1 mm, at least about 0.25 mm, at least about 1 mm, at least about 2 mm, or even at leastabout 5 mm.

### Hot Melt Adhesive

The hot melt adhesive includes a polymer. In some embodiments, the hot melt adhesive consists essentially of a polymer. Examples of useful classes of polymer include polyethylene, ethylene copolymers (including e.g. ethylene vinyl acetate, ethylene methyl acrylate, ethylene ethyl acrylate, ethylene n-butyl acrylate, ethylene acrylic acid, ethylene methacrylate, ethylene methyl-methacrylate, ethylene 2-ethylhexyl acrylate), polypropylene copolymers, metallocene catalyzed polyolefins (e.g. polypropylene, ethylene octene, and ethylene butene), amorphous poly alpha olefins, polyamides, polyesters, polyurethanes, poly vinyl chloride (PVC), other halogenated polymers and combinations thereof. Other polymers may include thermoplastic polyurethane or PET.

Suitable polymers can exhibit a melt index of from about 5 grams/10 minutes to about 3000 grams/10 minutes when measured in accordance with ASTM D-1238, condition 190° C., using a 2.16 kg weight (which is formally known as condition E).

Suitable ethylene vinyl acetate copolymers are commercially available under the ATEVA series of trade designations including ATEVA 1850A, 1880A, 2810A, 2830A, 2850A and 4030AC from AT Plastics, Inc. (Edmonton, Alberta, Canada), under the LEVAMELT series of trade designations including, e.g., LEVAMELT 800 and LEVAMELT KA8896 from Bayer Corporation (Pittsburgh, Pa.), and the ESCORENE series of trade designations including, ESCORENE MVO2514 and UL8705 from ExxonMobil Chemical Company (Houston, Tex.).

The hot melt adhesive can consist essentially of a polyamide. The polyamide is preferably prepared by a condensation reaction. The polyamide can include at least one dimer acid, at least one dicarboxylic acid and ethylene diamine.

Suitable dimer acids include, e.g., fatty acid hydrogenated dimers having, alkyl groups that include from 18 to 44 carbon atoms. Preferred dimer acids contain at least about 75% by weight of dimer, at least about 85% by weight of dimer, at least about 90% by weight of dimer, or even at least about 95% by weight of dimer. Useful commercially available dimer acids include the PRIPOL series of dimer acids available from Croda Uniquema Inc. (Chicago, Ill.). The amount of dimer acid present in the reaction mixture is from about 20% by weight to about 90% by weight, at least about 50% by weight, or even at least about 60% by weight.

Suitable dicarboxylic acids have an alkyl group that includes 6, 8, 10 or 12 carbon atoms. Examples of suitable dicarboxylic acids include sebacic acid, dodecanedioic acid, azelaic acid, adipic acid and combinations thereof. The amount of dicarboxylic acid present in the reaction mixture is from about 1% by weight to about 20% by weight, from about 2% by weight to about 15% by weight, or even no greater than about 10% by weight.

The amount of ethylene diamine present in the reaction mixture is from about 2% by weight to about 20% by weight, or even from about 5% by weight to about 15% by weight.

The reaction mixture may optionally include a chain terminator. Useful chain terminators include, e.g., stearic acid, hexadecanoic acid, monoamines including, e.g., benzyl amine, hexylamine, octadecylamine. The amount of chain terminator, when present in the reaction mixture, preferably is present in an amount of no greater than about 5 parts by weight, and can be present in an amount from about 0.1 parts by weight to about 3.5 parts by weight, and from about 1 part by weight to about 3.5 parts by weight.

The polyamide can have high heat resistance to enable use in engine air filter applications. In some applications, the Mettler Softening Point of the polyamide is greater than about 121.1° C. (250° F.), greater than about 148.9° C. (300° F.), or even greater than about 176.7° C. (350° F.).

The hot melt adhesive can optionally include at least one component selected from the group consisting of tackifying agent, wax and filler. Colorants or dyes could also optionally be added.

Suitable tackifying agents include natural and modified rosins such as gum rosin, wood rosin, tall oil rosin, distilled rosin, hydrogenated rosin, dimerized rosin and polymerized rosin; rosin esters such as glycerol and pentaerythritol esters of natural and modified rosins including, e.g., glycerol esters of pale, wood rosin, glycerol esters of hydrogenated rosin, glycerol esters of polymerized rosin, pentaerythritol esters of hydrogenated rosin and phenolic-modified pentaerythritol esters of rosin; phenolic modified terpene or alpha methyl styrene resins and hydrogenated derivatives thereof including, e.g., the resin product resulting from the condensation in an acidic medium of a bicyclic terpene and a phenol; aliphatic petroleum hydrocarbon resins having a Ball and Ring softening point of from about 70° C. to about 140° C.; the latter resins resulting from the polymerization of monomers consisting primarily of olefins and diolefins; including hydrogenated aliphatic petroleum hydrocarbon resins; aromatic petroleum hydrocarbon resins, and mixed aromatic and aliphatic paraffin hydrocarbon resins and the hydrogenated derivatives thereof; aromatic modified alicyclic petroleum hydrocarbon resins and the hydrogenated derivatives thereof; alicyclic petroleum hydrocarbon resins and the hydrogenated derivatives thereof; styrenated terpenes; and combinations thereof. Examples of commercially available suitable tackifying agents include ESCOREZ 5000 series of hydrogenated cyclic hydrocarbon resins, ESCOREZ 1000 series aliphatic hydrocarbon resins, and ESCOREZ 2000 series aromatically modified hydrocarbon resins all of which are available from ExxonMobil Chemical (Houston, Tex.) and the EASTOTAC series of cycloaliphatic hydrocarbon resins available from Eastman Chemical Company. (Kingsport, Tenn.)

Suitable classes of waxes include, e.g., paraffin waxes, chlorinated paraffin waxes, Fischer-Tropsch waxes, by-product polyethylene waxes, high-density low molecular weight polyethylene waxes, microcrystalline waxes, and vegetable waxes. Examples of commercially available suitable waxes includes PACEMAKER 155 paraffin wax from Citgo Petroleum (Houston, Tex.), CHLOREZ 700-SSNP chlorinated paraffin wax from Dover Chemical Corporation (Dover, Ohio), low molecular weight by-product polyethylene waxes commercially available under the trade designation MARCUS 100, 200 and 300, from Marcus Chemical Co., a Division of H.R.D. Corp. (Houston, Tex.), Fischer-Tropsch waxes commercially available under the trade designations PARAFLINT H-1, H-4 and H-8 from Sasol-SA/Moore & Munger (Shelton, Conn.), BARECO PX-105, from Baker Petrolite Corporation (Sugarland, Tex.), and SARAWAX SX-70 Fischer-Tropsch wax from Shell MDS (Bintulu, Malaysia).

Suitable classes of fillers include, e.g. calcium carbonate, magnesium carbonate kaolin (commonly called clay), talc, barium sulfate, hydrated inorganic compounds (e.g. alumina trihydrate, magnesium hydroxide, hydrated calcium silicates, hydrated calcium carbonates), zinc oxide, borates (e.g. zinc borate and barium borate), surface modified versions thereof; and combinations thereof. Examples of commercially available suitable fillers include HUBERCARB Q-325 available from J.M Huber Corporation (Quincy, Ill.) and A-208 ALUMINA TRIHYDRATE available from RJ Marshall Company (Southfield, Mich.).

The hot melt adhesive may include flame retardant or smoke suppressing components such as those disclosed in U.S. Pat. No. 5,962,129, U.S. Pat. No. 6,239,208, U.S. Pat. No. 6,943,207 and U.S. Pat. No. 7,205,047 incorporated herein in their entirety.

The hot melt adhesive can further include other components such as for example plasticizers (e.g. liquid elastomers and oil), pigments, UV stabilizers and antioxidants. Examples of commercially available suitable anitoxidants include Irganox 1076 and Irganox 1010 available from Ciba-Geigy Corporation (Hawthorne, N.Y.).

The hot melt adhesive preferably has a viscosity at 149° C. (300° F.) of >about 500 cps, >about 1000 cps, >about 2500 cps, >about 5000 cps, >about 10,000, >about 25,000 cps, >about 35,000 cps, or even between about 500 cps and about 25,000 cps.

Alternately, the hot melt can have a viscosity of between about 500 cps and about 25,000 cps at 204° C. (400° F.).

If desired, the hot melt adhesive could be formulated to be a pressure sensitive whereby the coated continuous substrate adheres upon contact without the need of heat. It may be desirable to coextrude a pressure sensitive material and a non-tacky polymer/adhesive onto the continuous substrate, for example where a tape is formed. This would enable winding the pressure sensitive adhesive tape onto a spool.

Hot Melt Adhesive Coated Continuous Substrate The continuous substrate is coated on at least one surface with a hot melt adhesive, or even on at least two opposing surfaces, or even on the entire external surface. The coating can be accomplished by any method.

In one method, a string is submerged entirely in a molten hot melt adhesive; then while still molten it is passed through a bench top orifice system to finish the shape. The orifice diameter can be greater than about 0.038 cms (0.015 inches), greater than about 0.064 cms (0.025 inches), greater than about 0.089 cms (0.035 inches), or even greater than about 0.127 cms (0.050 inches). In another method, a bead is extruded on a string and then passed through a roller to create a flat tape. In still another method, a flat tape may be created by slot extrusion. In still another method, roll coating is used to coat the continuous substrate.

In some configurations, replacing the molten adhesive with a continuous substrate including hot melt adhesive lowers the amount of adhesive needed thereby lowering the cost of the filter. The hot melt adhesive coated continuous substrate can comprise, for example, at least about 40% by weight hot melt adhesive, at least about 60% by weight, at least about 80% by weight, at least about 90% by weight, from about 30% to about 95% by weight, or even from about 75% to about 85% by weight of hot melt adhesive.

Once coated with hot melt adhesive, the continuous substrate can be wound upon a roll for use at a later date. The hot melt adhesive coated continuous substrate is at least about 50 meters long, at least about 100 meters long, or even at least about 500 meters long.

When tested according to the Media Adhesion test the hot melt adhesive coated continuous substrate gives at least about 50% fiber tear, at least about 75% fiber tear, or even at least about 90% fiber tear when pulled at 20 minutes.

### Continuous Substrate Bonded Filter Media:

Filter media including a hot melt adhesive coated continuous substrate can be formed (“Continuous Substrate Bonded Filter Media”). The filter media can include for example cellulose, fiberglass, polyolefin (e.g. polyethylene, polypropylene) and polyester.

One possible method of bonding filter media to a hot melt adhesive coated continuous substrate includes obtaining a continuous substrate coated on at least one side with a hot melt adhesive, heating the hot melt adhesive coated substrate under tension and contacting the heated hot melt coated continuous substrate to filter media to form a bond and the continuous substrate bonded filter media. The coated continuous substrate can be coated during the process, or can be pre coated and reheated when bonding to the filter media is desired.

By heating the coated substrate under tension, the coated substrate won't curl and bend back to the shape of the roll. In one method, heating the coated substrate under tension is accomplished by holding a roll of the coated substrate on a tension roller with at least about 1 pound of tension. The tension is formed by a brake on the roller that prevents the roller from spinning freely. Under tension, the coated continuous substrate is then passed beneath an IR heat source.

In some methods, the continuous substrate is coated with hot melt adhesive at a location different from where the filter media is pleated i.e. pre coated. The inventors have discovered that this is advantageous to the filter manufacturer as it eliminates both a hot melt glue pot and related equipment (e.g. nozzles, hoses, premelters) and also the related maintenance of that equipment from the filter manufacturer's assembly line. This is particularly advantageous when the adhesive has poor heat stability or when it would require a high application temperature.

### Filter Pleating:

The hot melt coated continuous substrate can be applied to the filter media in any number of configurations. In one configuration, the hot melt coated continuous substrate is applied across the top flattened surface of the filter media in individual strands spaced equally across the width of the filter. (The term “flattened surface” simply refers to a surface that is substantially smooth and free from pleats, but includes scored or pre-pleated media that is flattened for application of the coated continuous substrate.) In another configuration, the hot melt coated continuous substrate is applied across both the top and the bottom flattened surface of the filter in individual strands spaced equally across the width of the filter. In still another configuration, the hot melt coated continuous substrate is applied in two strands across the top and/or bottom flattened surface of the filter, along the outside edges of the filter. In one configuration, the filter media is pre-pleated and then flattened prior to application of the hot melt coated continuous substrate on the flattened substrate. In still another configuration the hot melt coated continuous substrate is applied in an intermittent i.e. non continuous pattern.

Regardless of the configuration, once the hot melt coated continuous substrate is applied to the filter media, the media is pleated, such as in an accordion style, such that the hot melt coated continuous substrate bonds to itself to maintain the spacing of the pleats. Alternatively, the hot melt coated continuous substrate is applied such that when folded, the hot melt coated continuous substrate bonds to both opposing surfaces of the filter media pleat, thus maintaining the spacing of the pleats. In this embodiment, thicker hot melt coated continuous substrates may be advantageous. Intermittent application of the hot melt coated continuous substrate may also be particularly useful here. In any case, the hot melt coated continuous substrate can have an advantage in pleating versus a hot melt adhesive as the coated continuous substrate sets up faster to immediately hold the pleats apart.

### Pleat Stabilization:

In still another configuration the hot melt coated continuous substrate is laid across the top of an already pleated filter to add additional stability (i.e. as pleat stabilization adhesive). When used for pleat stabilization, the hot melt coated continuous substrate provides improved strength versus use of a hot melt bead alone. The hot melt coated continuous substrate can provide at least about 10 times, at least about 20 times, or even at least about 50 times the tensile strength of hot melt alone as tested according to the Comparative Strength Tensile Test.

In a cylinderical spiral wound filter the pleated filter media is wound around a core. In this type of filter often a pleat stabilization adhesive is applied in a spiral bead on top of the pleated filter media. In a second step, a mesh cage is often then put in place over the outside of the filter media and adhesive. The mesh cage can be made from for example polypropylene; the mesh cage provides additional strength to the filter and protects the filter media. The hot melt coated continuous substrate can be used to replace both the pleat stabilization adhesive and the mesh cage. In one configuration, it can be possible to construct a mesh cage from the hot melt coated continuous substrate.

Methods of Making, Pleated Filter Media with a Continuous Substrate Coated with a Hot Melt Adhesive:

In one method, forming the pleated filter comprising the continuous substrate can be done as a one step process wherein the heat required to adhere the continuous substrate to the filter media is sufficient to keep it flexible enough to bend and adhere as the filter is pleated.

Alternately, it may be necessary to heat the continuous substrate including hot melt adhesive more than once (for example: First when applying it to the filter media prior to pleating, and second, during pleating). The hot melt coated continuous substrate can be heated by any means including infra-red (IR), electric, inductive or radio frequency (RF). In one method, IR lamps are mounted in one or more locations on the filter pleating equipment to provide focused heat at the desired locations without unnecessarily exposing the filter media to heat.

The pleated filter media including a continuous substrate can be manufactured on any number of filter pleating machines including for example those made by Genuine Machine Design, Inc, (Rensselaer, Ind.), Solent Technology, Inc. (Columbia, S.C.) and Filtration Technology Systems, LLC (New Albany, Ind.).

The pleated filter can have any shape or size. In one possible configuration, the pleated filter has four sides with a depth of less than about 10.2 cms (4 inches), or even less than about 5.1 cms (2 inches). In another configuration, the pleated filter is cylinderical with pleated filter media surrounding the outside circumference of a central core. The pleated filter can be used for various applications including for example HVAC (Heating, Ventilation, and Air Conditioning) filters, HEPA (High Efficiency Particulate Air) filters for commercial and/or residential buildings and engine air filters.

### EXAMPLES

### Test Procedures

Test procedures used in the examples include the following. All ratios and percentages are by weight unless otherwise indicated.

### Viscosity

The melt viscosity of the hot melt adhesive is determined in accordance with the following procedure using a Brookfield Laboratories RVDVII+Thermosel Viscometer. The spindle used is a SC-27 spindle. A cutting blade is employed to cut samples into pieces small enough to fit into the 2.5 cm wide, 13 cm long (1 inch wide, 5 inches long) sample chamber. A 10.5-gram sample of the reactive hot melt is placed in the chamber, which is in turn inserted into a Brookfield Thermosel and locked into place with bent needle-nose pliers. The sample chamber has a notch on the bottom that fits the bottom of the Brookfield Thermosel to ensure that the chamber is not allowed to turn when the spindle is inserted and spinning. The sample is heated to the desired temperature e.g. 149° C. (300° F.). Next, the spindle is submerged into the sample chamber. As soon as the sample becomes molten, the viscometer apparatus is lowered, lowering is continued until brackets on the viscometer align on the Thermosel and the spindle attached. The viscometer is turned on, and set to a speed that, when taken in combination with the spindle number, leads to a torque reading of from 50% to 90% of the scale, as reflected on the display of the viscometer. The viscometer is allowed to run until the value stabilizes. A final reading is recorded in units of centipoise (cps).

### Mettler Softening Point

Mettler Softening Point is determined according to ASTM D-3461 test method entitled. “Standard Test Method for Softening Point of Asphalt and Pitch (Mettler Cup-and-Ball Method),” dated 1997.

### Media Adhesion

Hot melt adhesive coated string is prepared. 1000 denier polyester string is pulled through molten hot melt adhesive and then passed through a 0.142 cm (0.056 in) bench top orifice system to finish the shape. The coated string is then cut into pieces 6″ inches long. The pieces of string are laid on HEPA microglass filter media and placed in an oven set at 133° C. (271° F.) for various times. At the end of the specified time, the string is pulled from the HEPA microglass filter media. One sample is pulled at each temperature. The media and string are removed from the oven and allowed to cool to room temperature prior the being pulled. The amount of fiber tear is recorded. The amount of fiber tear is estimated based on 100% as showing fiber tear along entire bead.

### Comparative Strength Tensile Test

Prepare 3, 5.1 cms (2 inches) long, 0.089 cms (0.035 inch) diameter beads of the adhesive to be tested.

Prepare hot melt adhesive coated continuous substrate with a final diameter of 0.089 cms (0.035 inch). Samples are prepared by dipping a 1000 denier polyester string into molten hot melt adhesive and then passing the coated string through a 0.142 cms (0.056 inch) diameter bench top orifice system. It is necessary to pass the string through a larger orifice than the intended final diameter as the hot melt adhesive coated continuous substrate shrinks as it cools. Once cool and set the hot melt coated string is cut into 3, 5.1 cms (2 inches) long pieces.

Both sets of samples are aged for at least 24 hours prior to testing.

Samples are pulled to failure in a tensile mode with an Instron Machine (model #55R1123) set at a cross head speed of 1″/minute. Values are recorded in lbf. Report hot melt adhesive tested and an average of the three values in newtons/lbf.

TABLE ONE

| | Example 1- | Example 2- |
|---|---|---|
| | String | String |
| | coated with | coated with |
| Time in | HL8730 | HL6790 |
| Oven | % Fiber | % Fiber |
| (seconds) | Tear | Tear |
| 0 | 0 | 0 |
| 10 | 0 | 0 |
| 15 | 50 | 50 |
| 20 | 100 | 100 |
| 30 | 100 | 100 |
| 60 | 100 | 100 |
| 120 | 100 | 100 |
| 600 | 100 | 100 |

HL8730 is a non filled, non flame retardant hot melt adhesive commercially available from HB Fuller Company with a viscosity @ 149° C. (300° F.) of 2230 cps.
HL6790 is a filled, flame retardant and smoke suppressed hot melt adhesive commercially available from HB Fuller Company with a viscosity @ 149° C. (300° F.) of 14,200 cps.

TABLE TWO

| | Adhesive A |
|---|---|
| | (Values in weight %) |
| Ateva 2810A | 28.85 |
| Ateva 1850 A | 12.31 |
| Escorez 2303 LC | 4.13 |
| Escorez 5400 | 29.41 |
| Marcus 200 | 25 |
| Irganox 1076 | 0.3 |
| Viscosity @ 275° F. (135° C.) cps | 42,600 |

Ateva 2810A - ethylene vinyl acetate polymer, MI = 6, vinyl acetate content = 28%
Ateva 1850 A - ethylene vinyl acetate polymer, MI = 150, vinyl acetate content = 18%
Escorez 2203 LC - aromatic modified C-5 resin, softening point = 96° C.
Escorez 5400 - partially hydrogenated cylcloaliphatic resin, softening point = 103° C.
Marcus 200 - by-product polyethylene wax
Irganox 1076 - antioxidant

TABLE THREE
Comparative Strength Tensile Test

| | | Example 3 |
|---|---|---|
| | Comparative 1 | (1000 denier polyester string |
| | (bead of Adhesive A) | coated 100% with Adhesive A) |
| | Average Strength | Average Strength |
| Tensile | 1.51 newtons (0.34 lbf) | 81.9 newtons (18.42 lbf) |
| Strength | | |

Other embodiments are within the claims.

What is claimed is:

1. A filter comprising filter media and a continuous substrate coated on at least one surface with a hot melt adhesive, the hot melt adhesive comprising:
polymer; and
at least one component selected from the group consisting of tackifying agent, wax and filler.

2. The filter of claim 1 wherein the hot melt adhesive comprises a flame retardant or a smoke suppressant compound.

3. The filter of claim 1 wherein the at least one component of the hot melt adhesive is a filler.

4. The filter of claim 3 wherein the filler is a hydrated inorganic compound.

5. The filter of claim 1 wherein the at least one component of the hot melt adhesive is a wax.

6. The filter of claim 1 wherein the polymer is an ethylene copolymer.

7. The filter of claim 1 wherein the filter is an air filter.

8. The filter of claim 1 wherein the continuous substrate is a string.

9. The filter of claim 8 wherein the string comprises polyester.

10. A continuous substrate coated on at least one surface with a hot melt adhesive comprising a flame retardardant or smoke suppressant compound.

11. A continuous substrate coated on at least one surface with a polyamide hot melt adhesive comprising at least one dimer acid, at least one dicarboxylic acid and ethylene diamine.

12. An air filter comprising the continuous substrate of claim 11.

13. The air filter of claim 12 wherein the air filter is an engine air filter.

14. The air filter of claim 12 wherein the continuous substrate stabilizes the pleats of the filter.

15. A method comprising:
obtaining a coated continuous substrate, coated on at least one surface with a hot melt adhesive and filter media,
heating the coated continuous substrate under tension, and
contacting the heated, coated continuous substrate to the filter media creating a continuous substrate bonded filter media.

16. The method of claim 15 comprising an additional step of folding the continuous substrate bonded filter media to form pleats.

17. The method of claim 15 wherein the continuous substrate is contacted to the filter media after the filter media is pleated.

18. The method of claim 15 wherein said continuous substrate is heated with IR heat.

19. The method of claim 15 wherein the coated continuous substrate is pre coated.

20. A pleated filter made by the method of claim 15.
